(19) United States
(12) Patent Application Publication
(10) Pub. No.: US 2019/0392983 A1
(43) Pub. Date: Dec. 26, 2019

(54) Inductor's Electromagnetic Balance Improvement Method

(71) Applicants: Guang-Jin Chen, Shenzhen (CN); Bao-Liang Tan, Shenzhen (CN)

(72) Inventors: Guang-Jin Chen, Shenzhen (CN); Bao-Liang Tan, Shenzhen (CN)

(21) Appl. No.: 16/215,664

(22) Filed: Dec. 11, 2018

(30) Foreign Application Priority Data
Jun. 26, 2018 (CN) 201810669082.7

(51) Int. Cl. H01F 27/36; H01F 41/02; H01F 27/02; H01F 27/28

(52) U.S. Cl. CPC H01F 27/36; H01F 27/28; H01F 27/02; H01F 41/02

(57) ABSTRACT

This invention proposes an inductor's electromagnetic balance improvement method which equips protective box inside magnet ring with an arc-shaped shield. It can block out electromagnetism of magnet ring from all angles to reduce remanence, improve inductor's electromagnetic balance, and shorten the gap between action current of fire wire and that of naught wire. In this way, product yield rate can be increased.

### TECHNICAL FIELD

To be specific, this invention refers to an inductor's electromagnetic balance improvement method in the technical field of inductor manufacturing.

### TECHNICAL BACKGROUND

Now, electric appliances of new energy vehicles such as charging pile and instrument circuit tend to be equipped with mutual inductors like zero-sequence mutual inductor, common-mode inductor and differential-mode inductor. As shown by FIG. 1, magnet ring 1 made of electromagnetic material is sleeved in locating seat 5 in protective box 2. Since toroidal magnetic field faces a lack of balance because of existing inductors' inability to block out electromagnetism of magnet ring, there will be remanence when electric signal goes through magnet ring. The remanence can cut magnetic line of magnet ring's coil to result in null piezoelectricity, which may lead to instability of components in circuit board. For example, since earth leakage circuit breaker is intended to control grid power safety, and the fire wire and naught wire are set in locating seat of zero-sequence inductor, there will be a gap between residual operating current of fire wire and that of naught wire; according to tests, most of current gaps go beyond ±3 mA, which is higher than ±1 mA determined by international requirements. Obviously, existing inductors are incapable of meeting international circuit indicator requirements.

### CONTENTS OF INVENTION

This invention proposes an inductor's electromagnetic balance improvement method to address existing technical problems concerning existing technical defects. It can block out electromagnetism of magnet ring to reduce remanence, improve inductor's electromagnetic balance and shorten the gap between inaction current of fire wire and that of naught wire to improve product yield rate.

This invention adopts technical scheme as follows: the inductor's electromagnetic balance improvement method equips protective box inside magnet ring with an arc-shaped shield.

As for further improvements, the shield is designed as an enclosed circular tube.

The height of shield is smaller than that of magnet ring.

The height of shield matches up with that of protective box.

One side of the shield near magnet ring is much rougher than that far away from magnet ring.

The shield is constituted by any of NanoBlock, amorphous materials, silicon steel sheet and permalloy.

The shield is situated between locating seat in protective box and magnet ring.

The shield is situated on the inner wall of locating seat.

### Beneficial Results

This invention has following advantages as compared with existing technologies:

This invention proposes an inductor's electromagnetic balance improvement method which equips protective box inside magnet ring with an arc-shaped shield. It can block out electromagnetism of magnet ring from all angles to reduce remanence, improve inductor's electromagnetic balance and shorten the gap between inaction current of fire wire and that of naught wire.

This invention meeting requirements of international standards equips magnet ring with shield's inductor. Without the need for an electromagnetic balance test over inductor, this invention can save the cost and improve product yield so that inductor can be applied to all kinds of instruments in new energy vehicles to enhance safety.

### EXPLANATIONS ON FIGURES

FIG. 1: structural diagram of inductor in existing technologies;

FIG. 2: structural diagram of inductor in example 1 of this invention;

FIG. 3: structural diagram of inductor's shield in this invention;

FIG. 4: structural diagram of inductor in example 2 of this invention.

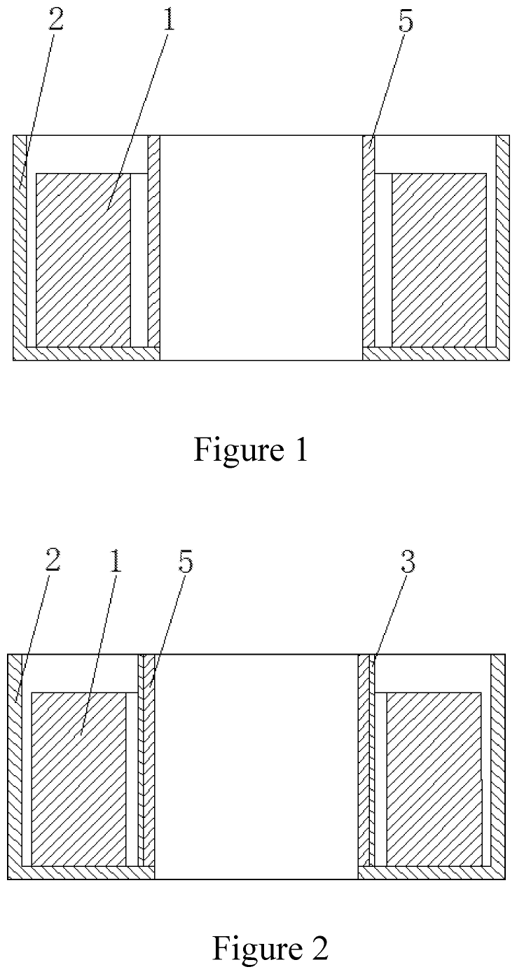

Where: 1—magnet ring, 2—protective box, 3—shield, 4—line; 5—locating seat.

### SPECIFIC IMPLEMENTATION MODE

Further explanations on this invention will be made according to examples in the figures:

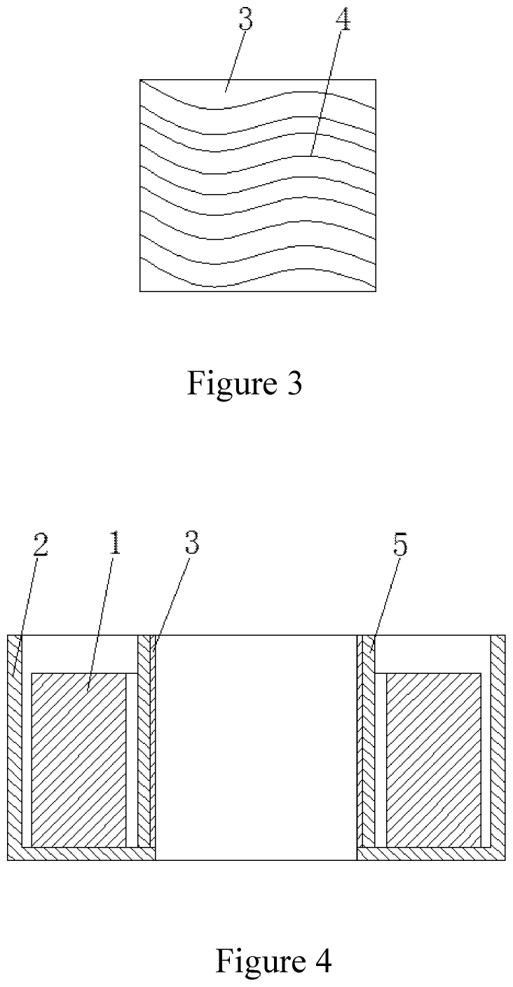

This invention proposes an inductor's electromagnetic balance improvement method which equips protective box 2 inside magnet ring 1 with an arc-shaped shield 3. It can block out electromagnetism of magnet ring 1 from all angles to reduce remanence. Meanwhile, there is a need for at least one layer of shield. In theory, the shielding effect over electromagnetism will become better as number of shield 3's layers increases. During installation, the height of shield 3 shall not be smaller than that of magnet ring 1 so that the axial area of magnet ring 1 can be fully covered to block out electromagnetism of magnet ring 1. Preferably, the height of shield 3 shall match up with that of protective box 2 so that shield 3 can be sealed up along with protective box 2 to avoid loosening. Furthermore, shield 3 is installed in protective box 2 through a slot. To be specific, there is a locating slot at the bottom of protective box 2, through which shield 3 can be fixed in protective box 2 quickly, or three-point locating pile through which shield 3 can be quickly installed in protective box 2 may be also designed at the bottom of protective box. Its ultimate goal is to facilitate locating and installation of shield 3 to improve installation efficiency. To produce shield 3, the side of shield 3 near magnet ring 1 shall be much rougher than that far away from magnet ring 1; that is, the two sides should be different in roughness. During installation, the rougher side shall face magnet ring 1, to which the other side shall turn its back. In this way, the shielding effect can be improved when the rougher side corresponds to magnet ring 1. Preferably, FIG. 3 shows that there are lines 4 at the rougher side of shield 3, which can contribute to better shielding effects. The aforesaid shield 3 is a thin film, which is made of any of following materials including NanoBlock, amorphous materials, silicon steel sheet and permalloy that can heighten shielding effects. Preferably, as compared with other materials, NanoBlock is more easily acquired and processed and less costly, which can address the problems like high material costs. The method in this invention can block out electromagnetism of magnet ring from all angles to reduce remanence, which can contribute to improving inductor's electromagnetic balance and shortening the gap between inaction current of fire wire and that of naught wire. This invention meeting requirements of international standards equips magnet ring with shield's inductor. Without the need for an electromagnetic balance test over inductor, this invention can save the cost and improve product yield so that inductor can be applied to all kinds of instruments in new energy vehicles to enhance safety.

### Example 1

FIG. 2 displays an example of this invention, in which shield (3) is situated between locating seat (5) in protective box and magnet ring (1). It can be added to existing inductor for improvements, convenient assembly and installation, as well as bring down production cost effectively.

### Example 2

FIG. 4 provides another example of this invention, which installs shield 3 in the inner wall of locating seat 5 in protective box 2. Shield 3 can be embedded in the inner wall of locating seat 5 to constitute a whole with protective box 2. At the same time, it can be wrapped in fire wire and naught wire, and then installed in the inner wall of locating seat 5 in protective box with them. This can reduce assembly and installation steps of shield 3 to greatly improve production efficiency and decrease labor intensity.

All above are the preferable implementation modes in this invention. It is worth noticing that on the premise of adopting structure of this invention, any changes or improvements made by technicians in this field shall not affect the implementation results of this invention and patent's practicality.

1. The inductor's electromagnetic balance improvement method equips protective box (2) inside magnet ring (1) with an arc-shaped shield (3).

2. As described by claim 1, the shield (3) is designed as an enclosed circular tube.

3. As described by claim 1, the height of shield (3) in the inductor's electromagnetic balance improvement method is smaller than that of magnet ring (1).

4. As described by claim 1, the height of shield (3) in the inductor's electromagnetic balance improvement method matches up with that of protective box (2).

5. As described by claim 1, one side of the shield (3) near magnet ring (1) in the inductor's electromagnetic balance improvement method is much rougher than that far away from magnet ring (1).

6. As described by claim 1, the inductor's electromagnetic balance improvement method uses any of NanoBlock, amorphous materials, silicon steel sheet and permalloy to produce shield (3).

7. As described by claim 1, the inductor's electromagnetic balance improvement method described, shield (3) is situated between locating seat (5) in protective box and magnet ring (1).

8. As described by claim 2, the inductor's electromagnetic balance improvement method described, shield (3) is situated between locating seat (5) in protective box and magnet ring (1).

9. As described by claim 3, the inductor's electromagnetic balance improvement method described, shield (3) is situated between locating seat (5) in protective box and magnet ring (1).

10. As described by claim 4, the inductor's electromagnetic balance improvement method described, shield (3) is situated between locating seat (5) in protective box and magnet ring (1).

11. As described by claim 5, the inductor's electromagnetic balance improvement method described, shield (3) is situated between locating seat (5) in protective box and magnet ring (1).

12. As described by claim 6, the inductor's electromagnetic balance improvement method described, shield (3) is situated between locating seat (5) in protective box and magnet ring (1).

13. As described by claim 1, the inductor's electromagnetic balance improvement method described, shield (3) is situated in the inner wall of locating seat (5).

14. As described by claim 2, the inductor's electromagnetic balance improvement method described, shield (3) is situated in the inner wall of locating seat (5).

15. As described by claim 3, the inductor's electromagnetic balance improvement method described, shield (3) is situated in the inner wall of locating seat (5).

16. As described by claim 4, the inductor's electromagnetic balance improvement method described, shield (3) is situated in the inner wall of locating seat (5).

17. As described by claim 5, the inductor's electromagnetic balance improvement method described, shield (3) is situated in the inner wall of locating seat (5).

18. As described by claim 6, the inductor's electromagnetic balance improvement method described, shield (3) is situated in the inner wall of locating seat (5).
